(19) United States
(12) Patent Application Publication
(10) Pub. No.: US 2014/0016304 A1
(43) Pub. Date: Jan. 16, 2014

(54) LED BACKLIGHT DRIVING CIRCUIT, BACKLIGHT MODULE, AND LCD DEVICE

(71) Applicants: Xinming Gao, Shenzhen (CN); Fei Li, Shenzhen (CN); Xiang Yang, Shenzhen (CN)

(72) Inventors: Xinming Gao, Shenzhen (CN); Fei Li, Shenzhen (CN); Xiang Yang, Shenzhen (CN)

(21) Appl. No.: 13/582,420

(22) PCT Filed: Jul. 16, 2012
(86) PCT No.: PCT/CN12/78710

§ 371 Date: Sep. 1, 2012

(30) Foreign Application Priority Data
Jul. 10, 2012 (CN) 201210237007.6

(51) Int. Cl. G09F 13/04

(52) U.S. Cl. 362/97.2; 362/97.1

(57) ABSTRACT

A backlight driving circuit includes a plurality of display areas, and each display area includes a first LED light cluster and a second LED light cluster which are symmetrical. The first LED light cluster and the second LED light cluster are connected in series to form a plurality of LED lightbars connected in parallel connection at two ends of the power source of the backlight driving circuit. Because the LED light clusters of the same display area are connected in series namely more than two small lightbars are connected in series to form a large LED lightbar, the small lightbars only occupy one pin of the constant current circuit. The LEDs on both sides of the same display area of the 3D display device can be simultaneously turned on or simultaneously turned off, and can be completely connected in series for use.

### TECHNICAL FIELD

The present disclosure relates to the field of liquid crystal displays (LCDs), and more particularly to a light emitting diode (LED) backlight driving circuit, a backlight module, and an LCD device.

### BACKGROUND

As shown in FIG. 1, a boost circuit structure is generally used in a backlight driving circuit. When a metal-oxide-semiconductor field-effect transistor (MOSFET) Q1 is switched on, an inductor L1 stores energy and when the MOSFET Q1 is switched off, the inductor L1 releases energy. Thus, an output voltage is higher than an input voltage constant current circuit supplies a constant current of LED light strings. An impedance of a MOSFET Q2 is controlled to enable a voltage of a resistor R1 to be equal to a reference voltage Vref to achieve a constant current. When an LCD device is of a three-dimensional (3D) type, to reduce crosstalk, a backlight module of a partition scanning type is generally used. Symmetrical LED lightbars are required by partition scanning. FIG. 2 shows a connection mode of the LED lightbars when the backlight module of a partition scanning type is divided into eight zones. Thus, the LED lightbars are divided into sixteen zones, and then sixteen pins are required by the constant current circuit in order to maintain a constant current, resulting in increased costs of the constant current circuit. Sometimes, two-dimensional (2D) LCD device can use the backlight driving scheme as well, and power consumption can be reduced.

### SUMMARY

In view of the above-described problems, the aim of the present disclosure is to provide an LED backlight driving circuit, a backlight module, and an LCD device capable of reducing the cost of a constant current circuit.

The aim of the present disclosure is achieved by the following technical scheme.

An LED backlight driving circuit comprises a plurality of display areas, and each display area comprises at least two LED light clusters. The at least two LED light clusters of each display area are arranged in series, and a plurality of LED lightbars in parallel connection at two ends of a power source of the backlight driving circuit.

The LED backlight driving circuit further comprises a connector, and each display area comprises a first LED light cluster and a second LED light cluster. The first LED light cluster is coupled with the second LED light cluster by the connector, and the first LED light cluster and the second LED light cluster are connected with the power source by the connector. Using the connectors, different LED light clusters can be conveniently connected in series and each LED light cluster can be used as a single general part, which can be applied to the present disclosure, and can be applied to the existing typical LCD devices.

The connector comprises an anode connector, a cathode connector, a first connector, and a second connector. Both an input end and an output end of the first LED light cluster are coupled to the first connector, and both an input end and an output end of the second LED light cluster are coupled to the second connector, an anode of the power source is coupled to the anode connector, and a cathode of the power source is coupled to the cathode connector. This is a specific connector type. The parts butted with all the components are connected by the connectors, facilitating assembly.

Preferably, the output end of the first LED light cluster is coupled to the input end of the second LED light cluster by the first connector, the anode connector, the cathode connector, and the second connector. In the technical scheme, the two LED light clusters are respectively connected with a connector, and are connected in series by the anode connector and the cathode connector at both ends of the power source. Thus, each LED light cluster is independent. Once one LED light cluster breaks down, the LED light cluster can be replaced by directly unplugging the corresponding connector without affecting other LED light clusters.

The output end of the first LED light cluster is coupled to the input end of the second LED light cluster by the first connector and the second connector. This is another series connection structure between the LED light clusters.

The input end of the LED lightbar is coupled with a boost circuit, and the output end of the LED lightbar is coupled with a buck-boost circuit. After the two LED light clusters are connected in series, the load of the LED lightbar of each branch is increased, high driving power of the power source is required, the voltage difference between both ends of the LED lightbar is increased through the cooperation of the boost circuit and the buck-boost circuit, and the driving power of the circuit is increased.

The LED backlight driving circuit comprises a converter module board coupled to the output end of each LED light cluster. The output end of the first LED light cluster is electrically connected with the input end of the second LED light cluster by the converter module board.

A backlight module comprises the LED backlight driving circuit mentioned above.

A 3D LCD device comprises the backlight module mentioned above.

The first LED light cluster and the second LED light cluster are respectively arranged on left and right sides of the LCD device. This is a specific distribution structure of the LED light clusters.

Preferably, the first LED light cluster and the second LED light cluster are respectively arranged on upper and lower ends of the LCD device. This is another specific distribution structure of the LED light clusters.

In the present disclosure because the LED light clusters of the same display area are connected in series for use, namely more than two small lightbars are connected in series to form a large LED lightbar, the original small lightbars only need to occupy one pin of the constant current circuit. The number of the pins of the constant current circuit is reduced by more than over half, and the cost of the constant current circuit is reduced. The scheme is particularly applied to the 3D display device with symmetrically distributed LEDs. The LEDs on both sides of the same display area of the 3D display device can be simultaneously turned on or simultaneously turned off, and can be completely connected in series. The pins of the constant current circuit can be reduced. Optionally, the scheme is completely applied to the 2D LCD device with backlight control.

### BRIEF DESCRIPTION OF FIGURES

FIG. 1 is a schematic diagram of a typical LED driving circuit;

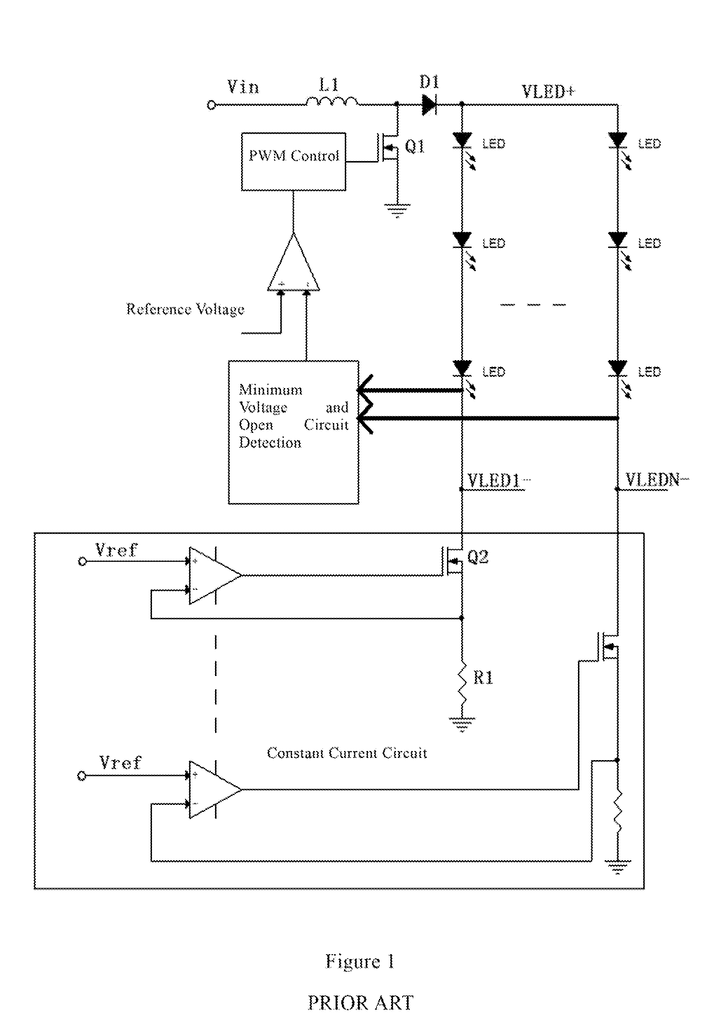

FIG. 2 is a schematic diagram of an LED light cluster of a typical 3D driving circuit;

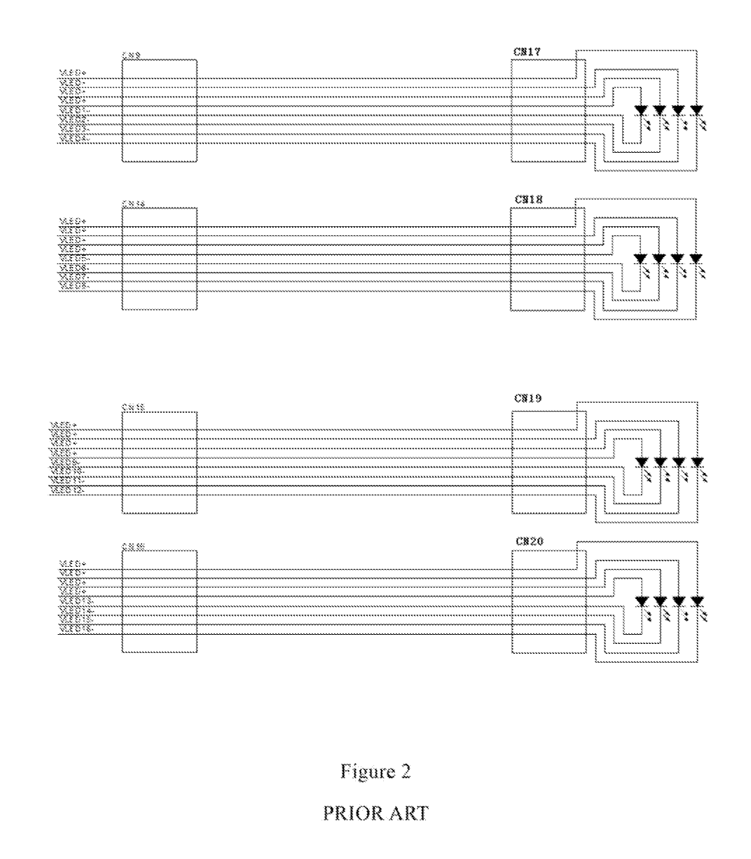

FIG. 3 is a schematic diagram of LED light clusters in series connection of an example of the present disclosure; and

FIG. 4 is a schematic diagram of a driving circuit with a buck-boost circuit of an example of the present disclosure.

Legends: 110. first LED light cluster; 120. second LED light cluster; 210. anode connector; 220. cathode connector; 230. first connector; 240. second connector.

### DETAILED DESCRIPTION

The present disclosure provides a three-dimensional (3D) LCD device comprising an LCD panel and a backlight module. The backlight module comprises an LED backlight driving circuit. The LED backlight driving circuit comprises a plurality of display areas, and each display area comprises at least two LED light clusters which are connected in series, to form a plurality of LED lightbars arranged in parallel connection at two ends of the power source of the backlight driving circuit.

In the present disclosure, because the LED light dusters of the same display area are connected in series, namely more than two small lightbars are connected in series to form a large LED lightbar, the small lightbars only occupy one pin of the constant current circuit. Thus, the number of the pins of the constant current circuit is reduced by more than half, and the cost of the constant current circuit is reduced. The scheme is particularly applied to the 3D display device with symmetrically distributed LEDs. The LEDs on both sides of a same display area of the 3D display device can be simultaneously turned on or simultaneously turned off, and can be completely connected in series. The pins of the constant current circuit can be reduced. Optionally, the scheme is completely applied to the 2D LCD device with backlight control.

The present disclosure will be further described in accordance with the Figures and exemplary examples.

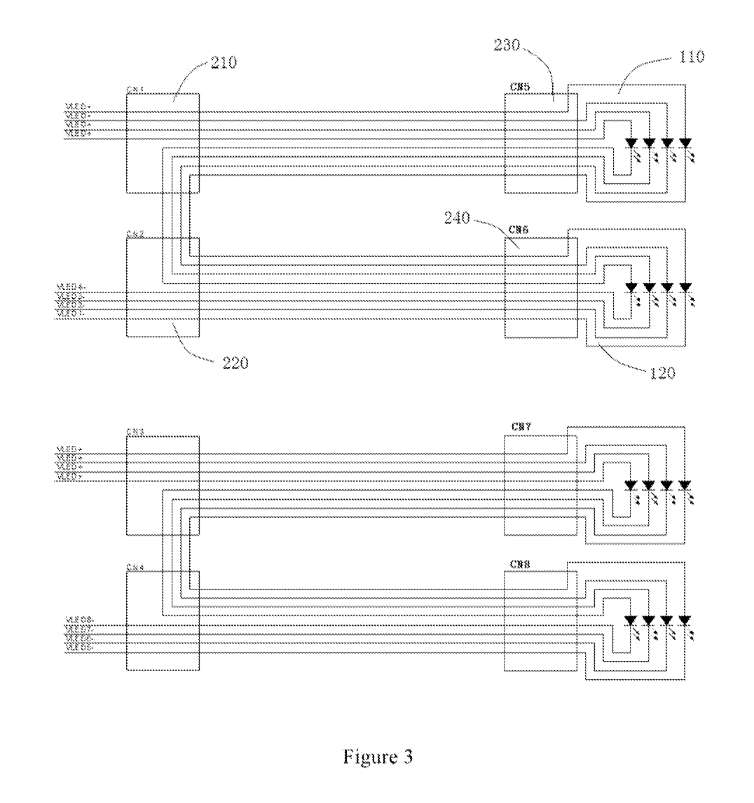

As shown in FIG. 3, each display area comprises a first LED light cluster 110 and a second LED light cluster 120. The first LED light cluster 110 and the second LED light cluster 120 are respectively arranged on the left and right sides or upper and lower ends of the LCD device and are symmetrically distributed about the display area The LED backlight driving circuit further comprises a connector. The first LED light cluster 110 is coupled with the second LED light cluster by the connector, and the first LED light cluster 110 and the second LED light cluster are connected with the power source by the connector. The connector comprises an anode connector 210, a cathode connector 220, a first connector 230, and a second connector 240. Both the input end and the output end of the first LED light cluster are coupled to the first connector 230. Both the input end and the output end of the second LED light cluster are coupled to the second connector 240. The anode of the power source is coupled to the anode connector 210, and the cathode of the power source is coupled to the cathode connector 220. The output end of the first LED light cluster 110 is coupled to the input end of the second LED light cluster by the first connector 230, the anode connector 210, the cathode connector 220, and the second connector 240.

Using the connectors, different LED light clusters can be conveniently connected in series, and each LED light cluster can be used as a single general part, which can be applied to the present disclosure, and can be applied to existing typical LCD devices. The parts butted with all the components are connected by connectors, facilitating assembly.

In the example, the two LED light clusters are respectively connected with one connector, and are connected in series by the anode connector 210 and the cathode connector 220 at both ends of the power source. Thus, each LED light cluster is independent. Once one LED light cluster breaks down, the LED light cluster can be replaced by directly unplugging the corresponding connector without affecting other LED light clusters.

Optionally, the output end of the first LED light cluster 110 can be coupled to the input end of the second LED light cluster by the first connector 230 and the second connector 240, namely the two are connected series at the light clusters.

Generally speaking, the LED backlight driving circuit comprises a converter module board coupled to the output end of each LED light cluster. Therefore, the output end of the first LED light cluster 110 can be connected with the input end of the second LED light cluster in series on the converter module board by soldering.

After the two LED light clusters are connected in series, the load of the LED lightbar of each branch is increased, and high driving power of the power source is required. Therefore, the input end of the LED lightbar can be coupled with a boost circuit, and the output end of the LED lightbar can be coupled with a buck-boost circuit. By the cooperation of the boost circuit and the buck-boost circuit voltage difference between both ends of the LED lightbar is increased, and the driving power of the circuit is increased.

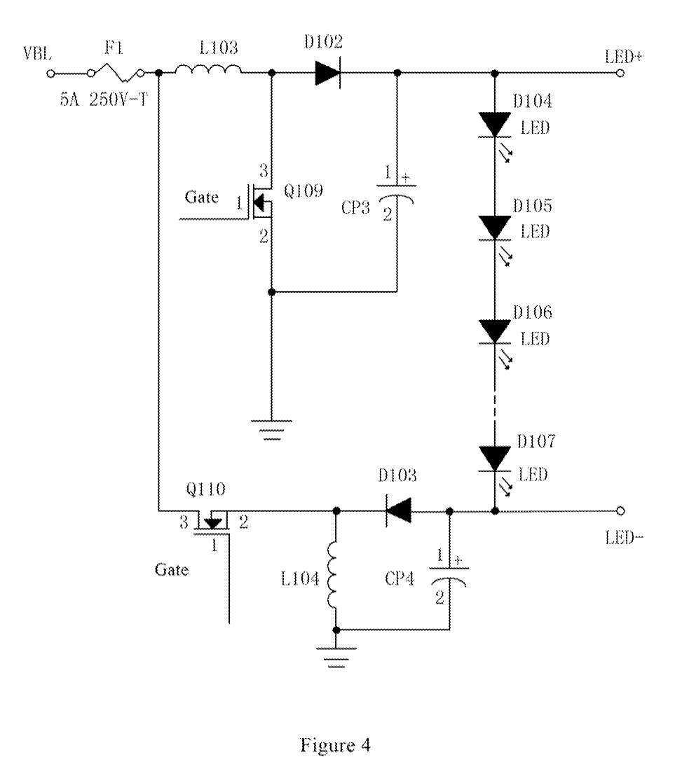

As shown in FIG. 4, both the input ends of the boost circuit and the buck-boost circuit are connected to the VBL, and the D104, the D105, the D106, and the D107 are connected in series to form an LED lightbar.

The boost circuit comprises a first inductor L103 and a first diode D102. One end of the inductor L103 is connected with the power source VBL, and another end of the inductor L103 is connected with a cathode of the first diode D102. An anode of the first diode D102 is connected with the anode of the LED lightbar, a first controllable switch Q109 is connected in series between the cathode of the first diode D102 and the ground terminal of the power source, and a first energy storage capacitor CP3 is in series connection between the anode of the first diode D102 and the ground terminal of the power source.

The buck-boost circuit comprises a second controllable switch Q110 and a second diode D103. One end of the second controllable switch D103 is connected with the power source VBL, and another end of the controllable switch D103 is connected with an anode of the second diode D103. A cathode of the second diode D103 is connected with the cathode of the LED lightbar, a second energy storage capacitor CP4 is in series connection between the cathode of the second diode D103 and the ground terminal of the power source, and a second energy storage inductor L104 is in series connection between the cathode of the second diode and the ground terminal of the power source. The control end of the first controllable switch is electrically connected with that of the second controllable switch. Thus, the same control signal can be used for control, thereby simplifying the control circuit.

In the circuit, because the LED lightbar is driven by a circuit having two different topology structures including a boost circuit formed by the first inductor L103, the first diode D102, and the first controllable switch Q109, which enables the power source VBL to be boosted to a certain high voltage to drive the anode of the LED lightbar, and a buck-boost circuit formed by the second inductor L104, the second diode D103, and the second controllable switch Q110, which enables the power source VBL to be degraded to a certain negative voltage to drive the cathode of the LED lightbar. Thus, limitation of the maximum voltage supplied by the single boost circuit is broken through and the voltage difference between the two ends of the LED lightbar is increased, thereby fully meeting driving requirements of the LED lightbars connected in series.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A light emitting diode (LED) backlight driving circuit, comprising:
a plurality of display areas, wherein each display area comprises at least two LED light clusters, and wherein the at least two LED light clusters of each display area are arranged in series; and
a plurality of LED lightbars arranged in parallel connection at two ends of a power source of the backlight driving circuit.

2. The LED backlight driving circuit of claim 1, wherein the LED backlight driving circuit further comprises a connector and wherein each display area comprises a first LED light cluster and a second LED light cluster; the first LED light cluster is coupled with the second LED light cluster by the connector, and the first LED light cluster and the second LED light cluster are connected with the power source by the connector.

3. The LED backlight driving circuit of claim 2, wherein the connector comprises an anode connector, a cathode connector, a first connector, and a second connector; both an input end and an output end of the first LED light cluster are coupled to the first connector; both an input end and an output end of the second LED light cluster are coupled to the second connector; an anode of the power source is coupled to the anode connector, and a cathode of the power source is coupled to the cathode connector.

4. The LED backlight driving circuit of claim 3, wherein the output end of the first LED light cluster is coupled to the input end of the second LED light cluster by the first connector, the anode connector, the cathode connector, and the second connector.

5. The LED backlight driving circuit of claim 3, wherein the output end of the first LED light cluster is coupled to the input end of the second LED light cluster by the first connector and the second connector.

6. The LED backlight driving circuit of claim 1, wherein the LED backlight driving circuit comprises a converter module board coupled to an output end of each LED light cluster; and an output end of a first LED light cluster is electrically connected with an input end of a second LED light cluster by the convener module board.

7. A backlight module, comprising:
a light emitting diode (LED) backlight driving circuit, wherein the LED backlight driving circuit comprises a plurality of display areas, and wherein each display area comprises at least two LED light clusters; and
wherein the at least two LED light clusters of each display area are arranged in series, and a plurality of LED lightbars are arranged in parallel connection at two ends of a power source of the backlight driving circuit.

8. The backlight module of claim 7, wherein the LED backlight driving circuit further comprises a connector and wherein each the display area comprises a first LED light cluster and a second LED light cluster; the first LED light cluster is coupled with the second LED light cluster by the connector, and the first LED light cluster and the second LED light cluster are connected with the power source by the connector.

9. The backlight module of claim 8, wherein the connector comprises an anode connector, a cathode connector, a first connector, and a second connector; both an input end and an output end of the first LED light cluster are coupled to the first connector; both an input end and an output end of the second LED light cluster are coupled to the second connector; an anode of the power source is coupled to the anode connector; and a cathode of the power source is coupled to the cathode connector.

10. The backlight module of claim 9, wherein the output end of the first LED light cluster is coupled to the input end of the second LED light cluster by the first connector, the anode connector, the cathode connector, and the second connector.

11. The backlight module of claim 9, wherein the output end of the first LED light cluster is coupled to the input end of the second LED light cluster by the first connector and the second connector.

12. The backlight module of claim 7, wherein the LED backlight driving circuit comprises a converter module board coupled to an output end of each LED light cluster; and an output end of a first LED light cluster is electrically connected with an input end of a second LED light cluster by the converter module board.

13. A three-dimensional (3D) liquid crystal display (LCD) device, comprising:
a backlight module of claim 8.

14. The 3D LCD device of claim 13, wherein the first LED light cluster and the second LED light cluster are respectively arranged on left and right sides of the LCD device.

15. The 3D LCD device of claim 13, wherein the first LED light cluster and the second LED light cluster are respectively arranged on upper and lower ends of the LCD device.
